(19) United States
(12) Patent Application Publication
(10) Pub. No.: US 2007/0057471 A1
(43) Pub. Date: Mar. 15, 2007

(54) Shaft Seal, Preferably for Steering Shafts of Vehicles, Especially Motor Vehicles

(75) Inventor: Klaus Rentschler, Oberstenfeld (DE)

Correspondence Address: GUDRUN E. HUCKETT DRAUDT, LONSSTR. 53, WUPPERTAL, 42289, DE

(73) Assignee: KACO GMBH + CO. KG, Heilbronn (DE)

(21) Appl. No.: 11/532,123

(22) Filed: Sep. 15, 2006

(30) Foreign Application Priority Data
Sep. 15, 2005 (DE) 10 2005 045 667.7

(51) Int. Cl. F16J 15/32

(52) U.S. Cl. 277/559

(57) ABSTRACT

A shaft seal has a support member and a sealing part having a sealing edge that seals a medium-containing space. The sealing part has at least one lubricating device on a side of the sealing part that is facing away from the medium-containing space. The at least one lubricating device is positioned in a receiving space and returns a medium, that has escaped from the medium-containing side into the receiving space by passing underneath the sealing edge when turning a shaft sealed by the shaft seal in a first direction, underneath the sealing edge from the receiving space into the medium-containing space when turning the shaft in a second direction opposite to the first direction.

### BACKGROUND OF THE INVENTION

The invention relates to a shaft seal, preferably for steering shafts of vehicles, in particular, motor vehicles. Such a shaft seal comprises a support member and a sealing part that has a sealing edge for sealing a medium-containing space.

In motor vehicles, there is often the problem that, when turning the steering wheel, the shaft seal that seals the steering shaft generates a whistling noise that is conceived as disturbing.

### SUMMARY OF THE INVENTION

It is an object of the present invention to configure a shaft seal of the aforementioned kind in such a way that the disturbing noise upon turning the steering wheel of the motor vehicle will no longer occur or will occur only at a much reduced noise level.

This object is solved by the present invention in that the sealing part on the side of the sealing edge that is facing away from the medium-containing space has at least one lubricating device that is positioned in a receiving space and that returns medium, that has escaped underneath the sealing edge as the steering wheel has been turned in a first direction, underneath the sealing edge when the steering wheel is turned in the second (opposite) direction.

This shaft seal according to the invention has a lubricating device with which the medium is guided underneath the sealing edge from the medium-containing space into the receiving space when turning the steering wheel. Upon turning the steering wheel in the other (opposite) direction, the medium is then returned by means of the lubricating device from of the receiving space underneath the sealing edge back into the medium-containing space that is to be sealed. In this way, the area underneath the sealing edge of the shaft seal is constantly lubricated when turning the steering wheel so that the disruptive whistling noise no longer occurs or occurs only to a minimal extent.

### BRIEF DESCRIPTION OF THE DRAWINGS

FIG. 1 shows in axial section one half of a shaft seal according to the invention.

FIG. 2 shows in an end view a contact surface of the shaft seal.

FIG. 3a shows an enlarged section illustration of a first configuration of a lubricating device according to the invention provided in the contact surface.

FIG. 3b shows an enlarged section illustration of a second configuration of a lubricating device according to the invention provided in the contact surface.

FIG. 3c shows an enlarged section illustration of a third configuration of a lubricating device according to the invention provided in the contact surface.

FIG. 3d shows an enlarged section illustration of a fourth configuration of a lubricating device according to the invention provided in the contact surface.

FIG. 4a shows in an end view a first arrangement of a lubricating device of the shaft seal according to the invention.

FIG. 4b shows in an end view a second arrangement of the lubricating device of the shaft seal according to the invention.

FIG. 4c shows in an end view a third arrangement of the lubricating device of the shaft seal according to the invention.

FIG. 4d shows in an end view a fourth arrangement of the lubricating device of the shaft seal according to the invention.

FIG. 4e shows in an end view a fifth arrangement of the lubricating device of the shaft seal according to the invention.

### DESCRIPTION OF PREFERRED EMBODIMENTS

The shaft seal is advantageously used in the automotive sector. However, it can also be used in other technical applications for sealing shafts and the like. The shaft seal has in axial section an L-shaped support member 1 that is made of metal or another hard material, particularly plastic. The cylindrical outer wall 2 of the support member 1 that is coaxial to the shaft seal has a continuously curved transition into a radially extending bottom member 3. The bottom member 3 has centrally a circular opening 4. The outer side 5 of the support member wall 2 is covered by a casing 6 that serves in the mounted state of the shaft seal as a stationary seal. In order to ensure a secure seat of the shaft seal in the mounting space, the outer side 7 of the casing 6 is profiled to have a wave shape (is undulated). When pressing the shaft seal into the mounting space, this wave-shaped (undulated) profile is elastically deformed so that a proper seat and excellent sealing action are ensured. The free end face 8 of the support member wall 2 is at least partially covered by the casing 6. The casing 6 extends also across the outer and inner sides of the bottom member 3 of the support member 1. As shown in FIG. 1, the thickness of the casing 6 at the inner side 9 of the support member wall 2 decreases or tapers continuously. The casing 6 is spaced from the end face 8 at the inner side 9.

The casing 6 comprises the sealing part 10 with sealing lip 11 that, when in the mounted position, rests with elastic pretension or pre-stress by means of a rounded sealing edge 12 against the shaft to be sealed. The end of the sealing part 10 opposite the sealing edge 12 is provided with a recess 13 in which a pressure spring 14 is positioned that loads the sealing edge 12 in the mounted position in the radial direction.

The sealing edge 12 is axially recessed relative to the end face 8 of the support memberwall 2. The pressure spring 14 is positioned completely within the receiving space 15 that is surrounded by the support member wall 2.

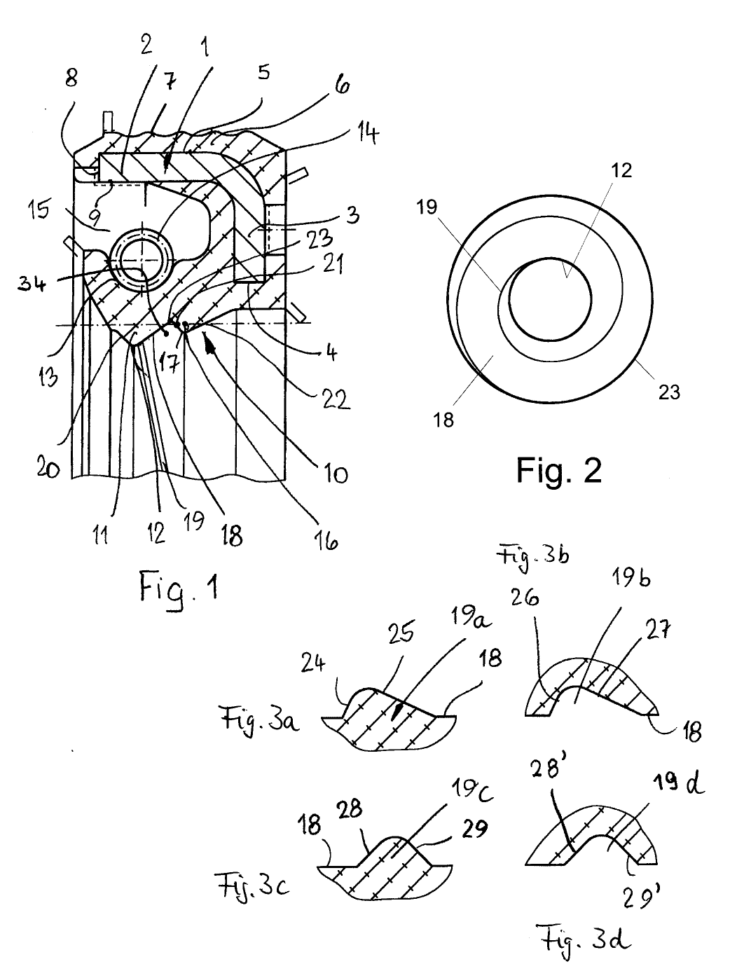

At an axial spacing relative to the sealing lip 11 the sealing part 10 is provided with a protective lip 16 whose sealing edge 17 has a greater diameter than the sealing edge 12 of the sealing lip 11. In the area between the two sealing edges 12 and 17, a conical contact surface 18 is provided that forms a bottom part of a receiving space 34 and has a lubricating device 19 (FIG. 2). By means of the lubricating device, medium that escapes underneath the sealing edge 12 is returned, as is known in the art. The diameter of the contact surface 18 increases from the sealing edge 12 in the direction toward the sealing edge 17. The contact surface 18 passes into the conical outer surface 20; where the two surfaces 18, 20 meet, the sealing edge 12 is formed. On the other end, the contact surface 18 adjoins approximately at a right angle a transverse wall in the form of a conical surface 21 that passes at an obtuse angle into the conical surface 22; where the two surfaces 21, 22 meet, the sealing edge 17 is formed.

The casing 6 and the sealing part 11 are advantageously a monolithic part that is comprised of an appropriate material known in the art.

As shown in FIG. 2, the lubricating device 19 extends spirally within the contact surface 18. Beginning at the sealing edge 12, the spiral lubricating device 19 extends in a counter-clockwise direction in a view onto the contact surface 18 and ends at a spacing from the transition 23 of the contact surface 18 into the conical surface 21.

The lubricating device 19 can have different cross-sectional shapes. Examples are shown in FIGS. 3a to 3d.

In the embodiment according to FIG. 3a, the lubricating device 19 is formed by a rib 19a that projects from the contact surface 18 and is delimited by lateral surfaces 24, 25 of different lengths; the lateral surfaces 24, 25 have a curved transition into one another. The lateral surfaces 24, 25 are positioned approximately at a right angle relative to one another. The shorter lateral surface 24 adjoins at an obtuse angle the contact surface 18. The longer lateral surface 25 adjoins also at an obtuse angle the contact surface 18 but the angle is significantly greater than the angle of the lateral surface 24 relative to the surface 18. The longer lateral surface 25 faces the protective lip 16. The medium to be sealed that escapes underneath the sealing lip 11 is returned by the rib-shaped lubricating device 19 when the steering wheel is turned appropriately. In this way, the area underneath the sealing edge 12 is constantly lubricated when the steering wheel is turned since the medium when turning the steering wheel is transported back and forth between the medium-containing space and the receiving space 34.

The lubricating device according to FIG. 3b is formed by a recess or depression 19b in the contact surface 18. The depression 19b is the negative shape of the configuration of the rib 19a of the lubricating device 19 according to FIG. 3a. Accordingly, the recess 19 is delimited by two laterals surfaces 26, 27 of different lengths. The surfaces 26, 27 have a curved transition into one another.

The lubricating device 19 according to FIG. 3c is formed by a rib 19c that projects from the contact surface 18. The rib 19c is delimited by two identical lateral surfaces 28, 29 that have a curved transition into one another and are positioned at an obtuse angle relative to one another. The rib 19c is symmetrical in cross-section.

FIG. 3d shows a lubricating device 19 in the form of a recess 19d. The recess 19d is the negative shape of the rib 19c of the embodiment according to FIG. 3c. Accordingly, the recess 19d is delimited by two identical lateral surfaces 28′, 29′.

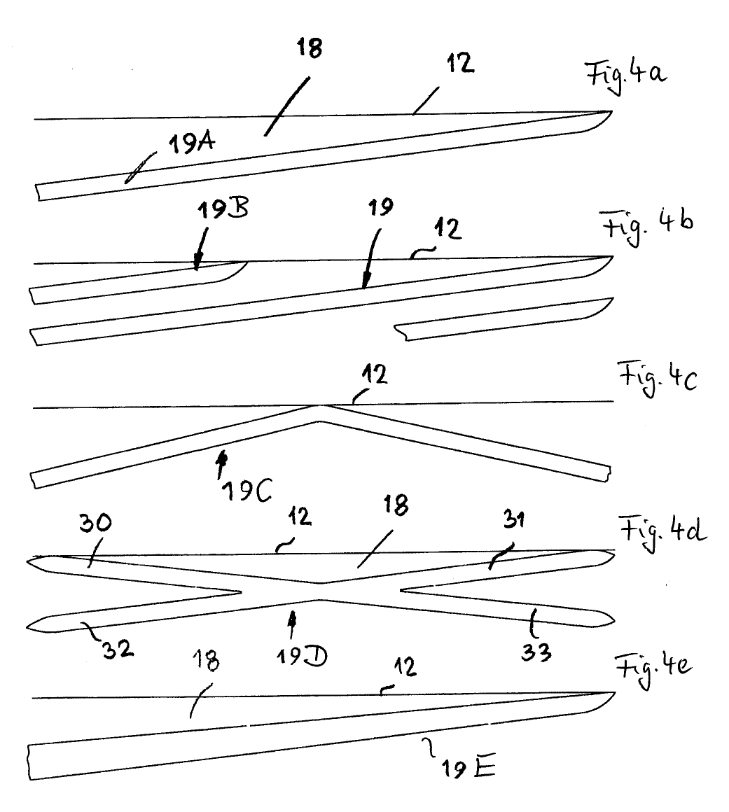

The lubricating device 19 can have rather different courses in the circumferential direction of the contact surface 18. Different arrangements are shown in FIGS. 4a to 4e.

According to FIG. 4a, the lubricating device 19A extends from the sealing edge 12 in a spiral shape. The lubricating device 19A has a constant width and a constant height across its length.

In the embodiment according to FIG. 4b, the lubricating device 19B is comprised of two spirally extending sections. The sections extend spirally from the sealing edge 12, respectively.

FIG. 4c shows an arrangement in which the lubricating device 19C extends from the sealing edge 12 in opposite directions in a V-shape. In this way, an optimal noise reduction is achieved in both rotational directions of the shafts to be sealed.

In the embodiment according to FIG. 4d, the lubricating device 19D is X-shaped in an view onto the contact surface 18. The two V-shaped sections 30, 31 of the lubricating device 19D are positioned at a small acute angle relative to the sealing edge 12 and point radially inwardly. The oppositely positioned sections 32, 33 of the lubricating device 19D end at a spacing relative to the conical surface 21. The lubricating device 19D is symmetric.

The lubricating device 19E according to FIG. 4e is arranged spirally in the contact surface 18. In contrast to the configuration of FIG. 4a, the width of the lubricating device 19E increases continuously starting at the sealing edge 12.

The described lubricating devices ensure optimally that upon turning the steering wheel for moving the wheels of a motor vehicle no noise or at most only minimal noise is produced that it is hardly audible. This is achieved in the described way in that the lubricating device according to the invention is provided in such a way in the contact surface 18 that the medium passing underneath the sealing edge 12 is collected at the contact surface 18. The conical surface 21 forms the boundary in the axial direction of the lubricant receiving space 34 that is positioned opposite the sealing edge 12 where the lubricant that has escaped is collected when the steering wheel is turned in a first direction. When subsequently the steering wheel is turned in the opposite direction, the lubricant (medium) collected in the receiving space 34 is returned in the direction toward the sealing edge 12 and passes underneath the sealing edge 12 into the lubricant-containing space. In this way, the lubricant when turning the steering wheel for turning the wheels is transported out of the lubricant-containing space into the receiving space 34 and back. By means of this conveying mechanism, it is achieved in a simple way that the disturbing whistling noise upon turning the steering wheel is reduced.

The application incorporates by reference the entire disclosure of German priority application 10 2005 045 667.7 having a filing date of Sep. 15, 2005.

While specific embodiments of the invention have been shown and described in detail to illustrate the inventive principles, it will be understood that the invention may be embodied otherwise without departing from such principles.

What is claimed is:

1. A shaft seal comprising:
a support member;
a sealing part having a sealing edge that seals a medium-containing space;
wherein the sealing part has at least one lubricating device on a side of the sealing part that is facing away from the medium-containing space;
wherein the at least one lubricating device is positioned in a receiving space;
wherein the at least one lubricating device returns a medium, that has escaped from the medium-containing space into the receiving space by passing underneath the sealing edge when turning a shaft sealed by the shaft seal in a first direction, underneath the sealing edge from the receiving space into the medium-containing space when turning the shaft in a second direction opposite to the first direction.

2. The shaft seal according to claim 1, wherein the receiving space widens in a direction away from the sealing edge.

3. The shaft seal according to claim 1, further comprising a transverse wall that is spaced from the sealing edge and delimits the receiving space.

4. The shaft seal according to claim 1, wherein the at least one lubricating device is formed by at least one rib that projects from a bottom part of the receiving space.

5. The shaft seal according to claim 1, wherein the at least one lubricating device is formed by at least one depression in a bottom part of the receiving space.

6. The shaft seal according to claim 1, wherein the at least one lubricating device extends spirally.

7. The shaft seal according to claim 1, wherein the at least one lubricating device extends in a direction away from the sealing edge.

8. The shaft seal according to claim 1, wherein the at least one lubricating device has a constant width across a length of the at least one lubricating device.

9. The shaft seal according to claim 1, wherein a width of the at least one lubricating device increases away from the sealing edge.

10. The shaft seal according to claim 9, wherein the width increases continuously.

11. The shaft seal according to claim 1, wherein the at least one lubricating device is arranged in an X-shape on a bottom part of the receiving space.

12. The shaft seal according to claim 1, wherein the at least one lubricating device is arranged in a V-shape on a bottom part of the receiving space.

13. The shaft seal according to claim 1, wherein the at least one lubricating device is delimited by lateral surfaces that are positioned angularly relative to one another.

14. The shaft seal according to claim 12, wherein the lateral surfaces are positioned at an obtuse angle relative to a bottom part of the receiving space.
